(19) United States
(12) Patent Application Publication
(10) Pub. No.: US 2001/0005822 A1
(43) Pub. Date: Jun. 28, 2001

(54) Noise suppression apparatus realized by linear prediction analyzing circuit

(75) Inventors: Kensaku Fujii, Kawasaki (JP); Juro Ohga, Kanagawa (JP); Tsutoma Hoshino, Kawasaki (JP); Junichi Sakaguchi, Kawasaki (JP); Toshio Kora, Tokyo (JP)

Correspondence Address: HELFGOTT & KARAS, P.C., 60TH FLOOR, EMPIRE STATE BUILDING, NEW YORK, NY, 10118, US

(73) Assignee: FUJITSU LIMITED

(21) Appl. No.: 09/736,667

(22) Filed: Dec. 13, 2000

(30) Foreign Application Priority Data
Dec. 13, 1999 (JP) 11-353491

(51) Int. Cl. H04B 3/20

(52) U.S. Cl. 704/200

(57) ABSTRACT

A noise suppression apparatus is realized by at least one linear prediction analyzing circuit. Each linear prediction analyzing circuit includes: an adaptive filter which produces a linear prediction signal based on a first speech signal on which noise is superimposed, and outputs the linear prediction signal as a second speech signal in which the noise is suppressed; a subtraction unit which obtains a difference between the linear prediction signal and the first speech signal, and outputs the difference as a prediction error; and a coefficient updating unit which updates coefficients of the adaptive filter based on the first speech signal and the prediction error so as to minimize the prediction error. The noise suppression apparatus may includes a cascade connection of a plurality of linear prediction analyzing circuits each having the above construction. Alternatively, the linear prediction analyzing circuit may include: a lattice filter which produces a linear prediction signal based on a first speech signal on which noise is superimposed; and a subtraction unit which subtracts the linear prediction signal from the first speech signal, and outputs a remainder after subtraction, as a second speech signal in which the noise is suppressed.

### BACKGROUND OF THE INVENTION

1. Field of the Invention

The present invention relates to a noise suppression apparatus. In particular, the present invention relates to a noise suppression apparatus which suppresses noise which is superimposed on a speech signal in a highly noisy environment so that a signal-to-noise ratio increases, and a regenerated speech sound becomes easy to listen to.

2. Description of the Related Art

Since the telephone is a very useful tool for transmitting to a remote place information generated by a human being, the telephone is used in various environments. A typical example of a telephone system used in a special environment is an emergency telephone system provided in a highway tunnel. Since cars are running in a narrow space of the tunnel, a great amount of noise is generated in the highway tunnel. Since the great amount of noise is superimposed on the speech sound, it is difficult for a remote listener (and speaker) to listen to the speech sound, and such noisy speech sound imposes stress on the listener. Further, since the noise leaks from a microphone through an anti-sidetone circuit into a receiver in the telephone in the tunnel, it is also very difficult for the speaker in the tunnel to listen to speech sound of the remote speaker.

Therefore, there are demands for a technique of suppressing acoustic noise in noisy speech sound, and making the speech sound easy to listen to so that comfortable conversation can be carried out.

A most widely known technique of suppressing acoustic noise is the so-called spectral subtraction method (S. Boll, “Suppression of Acoustic Noise in Speech Using Spectral Subtraction,” IEEE Trans. ASSP-27, No. 2, April 1979, pp.113-120). The principle of the spectral subtraction method is explained below.

FIG. 11 is a diagram illustrating an example of a construction for making calculation for the spectral subtraction method. The construction of FIG. 11 comprises a Fourier transformation unit 101, a power spectrum calculation unit 102, a phase information extraction unit 103, a noise power spectrum storage unit 104, an adder 105, a multiplier 106, and an inverse Fourier transformation unit 107.

When a sound signal containing noise is input into the Fourier transformation unit 101, the Fourier transformation unit 101 calculates a Fourier transform of the sound signal, i.e., converts the sound signal in the time domain into a signal in the frequency domain. The power spectrum calculation unit 102 extracts a power spectrum from the signal in the frequency domain, and the phase information extraction unit 103 extracts phase information from the signal in the frequency domain. A noise power spectrum is stored in advance in the noise power spectrum storage unit 104. The adder 105 obtains a difference between the power spectrum obtained by the power spectrum calculation unit 102 and the noise power spectrum stored in the noise power spectrum storage unit 104. The multiplier 106 obtains a product of the difference obtained by the adder 105 and the phase information extracted by the phase information extraction unit 103. The product obtained by the multiplier 106 is supplied to the inverse Fourier transformation unit 107, and the inverse Fourier transformation unit 107 obtains an inverse Fourier transform of the product, i.e., converts the output of the multiplier 106 into a signal in the time domain. The inverse Fourier transform (i.e., signal in the time domain) obtained by the inverse Fourier transformation unit 107 is the sound signal in which the noise is suppressed.

However, in the spectral subtraction method, the power spectrum of noise must be obtained in advance of the above calculation. That is, the noise cannot be suppressed until the power spectrum of the noise is obtained. In addition, when the power spectrum of noise varies, the noise cannot be effectively suppressed. Further, since the above calculation is mainly made in the frequency domain, the Fourier transform and the inverse Fourier transform cause delay. For example, when a Fourier transform of a sound signal containing noise and being sampled with a sampling frequency of 8 kHz is calculated for a duration of 256 samples, which is a typical number of samples for which a Fourier transform is calculated, a delay of 256/8=32 milliseconds occurs.

### SUMMARY OF THE INVENTION

An object of the present invention is to provide a noise suppression apparatus which can suppress noise which is superimposed on a speech signal, by calculation in a short time.

(1) According to the first aspect of the present invention, there is provided a noise suppression apparatus comprising a linear prediction analyzing circuit which includes an adaptive filter which produces a linear prediction signal based on a first speech signal on which noise is superimposed, and outputs the linear prediction signal as a second speech signal in which the noise is suppressed; a subtraction unit which obtains a difference between the linear prediction signal and the first speech signal, and outputs the difference as a prediction error; and a coefficient updating unit which updates coefficients of the adaptive filter based on the first speech signal and the prediction error so as to minimize the prediction error.

(2) According to the second aspect of the present invention, there is provided a noise suppression apparatus comprising a cascade connection of first to n-th linear prediction analyzing circuits, where n is an integer greater than one, and each of the first to n-th linear prediction analyzing circuits includes an adaptive filter which produces a linear prediction signal based on a first speech signal on which noise is superimposed, and outputs the linear prediction signal as a second speech signal in which the noise is suppressed; a subtraction unit which obtains a difference between the linear prediction signal and the first speech signal, and outputs the difference as a prediction error; and a coefficient updating unit which updates coefficients of the adaptive filter based on the first speech signal and the prediction error so as to minimize the prediction error. The second speech signal output from the n-th linear prediction analyzing circuit which is arranged in a final stage of the cascade connection is an output signal of the noise suppression apparatus, and the second speech signal output from each of the first to (n−1)-th linear prediction analyzing circuits is supplied to one of the second to n-th linear prediction analyzing circuits which is arranged in a subsequent stage as the first speech signal.

The noise suppression apparatus according to the second aspect of the present invention also have one or any possible combination of the following additional features (i) and (ii).

(i) Each of the first to n-th linear prediction analyzing circuits may include a multiplier which obtains a product of the prediction error and a predetermined constant, and an adder which obtains as a third speech signal a sum of the product and the linear prediction signal. In this case, the third speech signal in the n-th linear prediction analyzing circuit, instead of the second speech signal, is the output signal of the noise suppression apparatus, and the third speech signal output from each of the first to (n−1)-th linear prediction analyzing circuits, instead of the second speech signal, is supplied to one of the second to n-th linear prediction analyzing circuits which is arranged in a subsequent stage as the first speech signal.

(ii) Each of the first to n-th linear prediction analyzing circuits may include a multiplier which obtains a product of the first speech signal and a predetermined constant, and an adder which obtains as a third speech signal a sum of the product and the linear prediction signal. In this case, the third speech signal in the n-th linear prediction analyzing circuit, instead of the second speech signal, is the output signal of the noise suppression apparatus, and the third speech signal output from each of the first to (n−1)-th linear prediction analyzing circuits, instead of the second speech signal, is supplied to one of the second to n-th linear prediction analyzing circuits which is arranged in a subsequent stage as the first speech signal.

(3) According to the third aspect of the present invention, there is provided a noise suppression apparatus comprising a linear prediction analyzing circuit which includes a lattice filter which produces a linear prediction signal based on a first speech signal on which noise is superimposed; and a subtraction unit which subtracts the linear prediction signal from the first speech signal, and outputs a remainder after subtraction, as a second speech signal in which the noise is suppressed.

(4) As explained above, according to the present invention, linear prediction analysis of a speech signal on which noise is superimposed is performed, and a prediction signal obtained by the linear prediction analysis is output as a speech signal in which the noise is suppressed. Therefore, it is not necessary to obtain a power spectrum of noise, and the noise can be suppressed substantially on a real-time basis. Thus, for example, when the noise suppression apparatus according to the present invention is used in an emergency telephone system in a highway tunnel, the sound of the conversation becomes clear and easier to listen to.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a diagram illustrating a basic construction of a noise suppression apparatus according to the present invention;

FIGS. 2(A) to 2(D) exhibit an example of a result of linear prediction by the sub-RLS method;

FIG. 3 is a diagram illustrating the construction of the noise suppression apparatus as the first embodiment of the present invention;

FIGS. 4(A) to 4(E) exhibit a result of noise suppression by repeating the operation of the sub-RLS method three times;

FIG. 5 is a diagram illustrating the construction of the noise suppression apparatus as the second embodiment of the present invention;

FIGS. 6(A) to 5(E) exhibit a result of noise suppression by the noise suppression apparatus of FIG. 5;

FIG. 7 is a diagram illustrating the construction of the noise suppression apparatus as the third embodiment of the present invention;

FIG. 8 is a diagram illustrating a construction of a lattice filter;

FIG. 9 is a diagram illustrating the construction of the noise suppression apparatus as the fourth embodiment of the present invention;

FIGS. 10(A) to 10(D) exhibit a result of noise suppression by the noise suppression apparatus of FIG. 9; and

FIG. 11 is a diagram illustrating an example of a construction for making calculation for the spectral subtraction method.

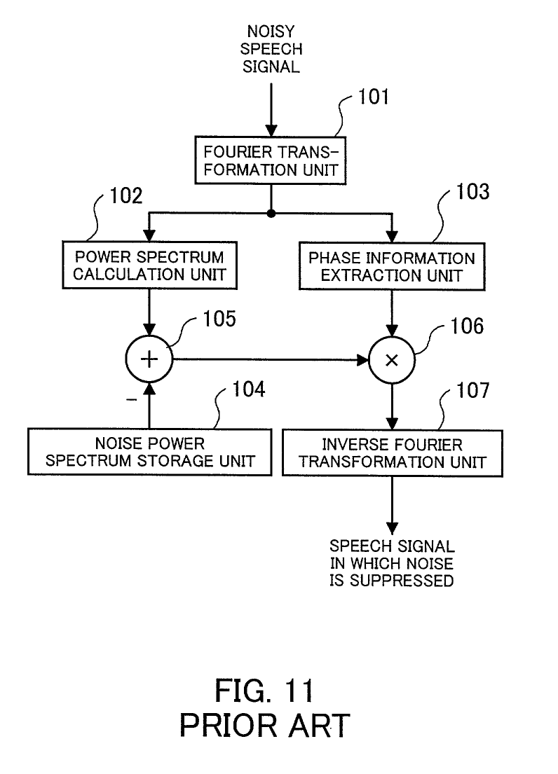

### DESCRIPTION OF THE PREFERRED EMBODIMENTS

Embodiments of the present invention are explained below with reference to drawings.

(1) Principle of Invention

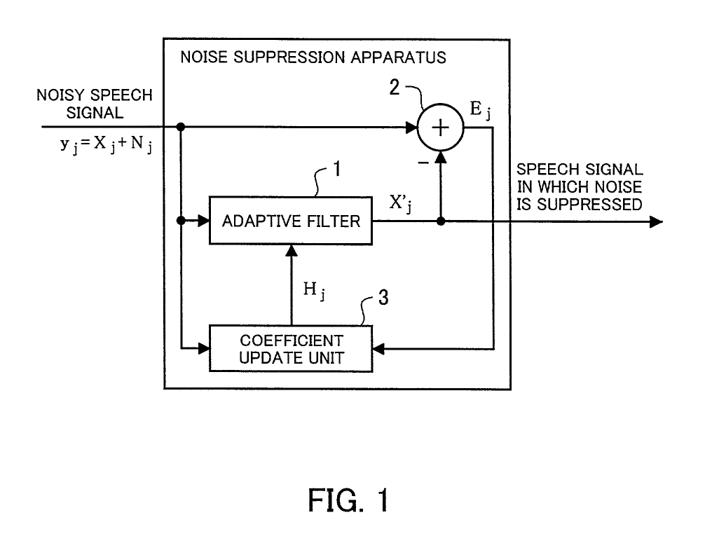

FIG. 1 is a diagram illustrating the basic construction of the noise suppression apparatus according to the present invention.

The noise suppression apparatus of FIG. 1 comprises an adaptive filter 1, a subtraction unit 2, and a coefficient update unit 3. A noisy speech signal containing noise is input into the adaptive filter 1, and the adaptive filter 1 calculates and outputs a linear prediction result. The subtraction unit 2 calculates and outputs as a prediction error signal a difference between the noisy speech signal and the linear prediction result. The coefficient update unit 3 updates coefficients in the adaptive filter 1 so as to minimize the prediction error signal. The output of the noise suppression apparatus is the above linear prediction result output from adaptive filter 1. That is, the noise suppression apparatus is realized by a linear prediction analyzing circuit.

The operation of the noise suppression apparatus of FIG. 1 is explained below in detail.

A noise signal Nⱼ is superimposed on a speech signal Xⱼ in the input signal yⱼ of the noise suppression apparatus, and the input signal yⱼ is expressed by the following equation (1), where j is a sample time index.

yⱼ=Xⱼ+Nⱼ (1)

When the input signal yⱼ is input into the noise suppression apparatus of FIG. 1, the coefficient update unit 3 updates the coefficients Hⱼ in the adaptive filter 1 so as to minimize the output signal Eⱼ of the subtraction unit 2 (i.e., the above prediction error signal). The coefficients Hⱼ in the adaptive filter 1 is expressed as

Hⱼ=[Hⱼ(1) Hⱼ(2) . . . Hⱼ(I)]^{T}. (2)

where I is the number of taps in the adaptive filter 1.

On the other hand, the output signal X′ⱼ of the adaptive filter 1 is obtained by synthesis of input signals yⱼ which are previously input into the adaptive filter 1, and each of the previous input signals yⱼ is a sum of a speech signal Xⱼ and a noise signal Nⱼ. That is, when the coefficients Hⱼ which minimize the prediction error signal Eⱼ is obtained, the speech signal Xⱼ and the noise signal Nⱼ are predicted with the minimized prediction error signal Eⱼ, based on the previous speech signals Xⱼ and the noise signals Nⱼ. For example, when the prediction error signal Eⱼ=0, the prediction is perfect. In other words, only predictable components of the speech signal Xⱼ constitute the output signal X′ⱼ of the adaptive filter 1. When it is assumed that the noise signal Nⱼ is white noise, the noise signal Nⱼ is unpredictable. Therefore, only the predictable components, i.e., only the speech signal Xⱼ appears as the output signal X′ⱼ of the adaptive filter 1. That is, a speech signal in which the noise signal Nⱼ is suppressed is obtained as the output of the noise suppression apparatus of FIG. 1.

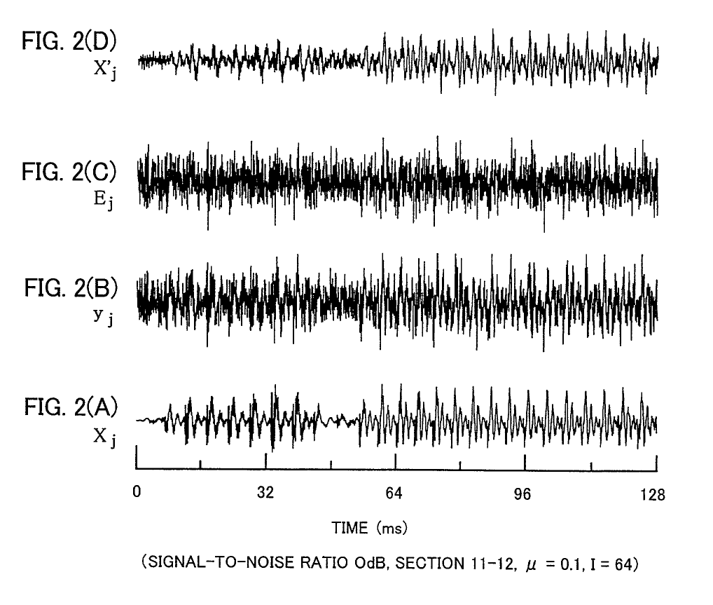

FIGS. 2(A) to 2(D) exhibit an example of a result of linear prediction by the so-called sub-RLS method, which is disclosed by K. Fujii and J. Ohga, “A New Recursive Type of Least Square Algorithm,” Technical Report of IEICE, EA96-71, November 1996, The Institute of Electronics, Information, and Communication Engineers in Japan. The result of FIGS. 2(A) to 2(D) is obtained in a high noise environment in which the power ratio of the speech signal and the noise signal is 0 dB. In FIGS. 2(A) to 2(D), waveshapes of an original speech signal Xⱼ, an input signal yⱼ (=Xⱼ+Nⱼ) in which a noise signal Nⱼ is superimposed on the speech signal Xⱼ, a prediction error signal Eⱼ (output from the subtraction unit 2), and a corresponding output signal X′ⱼ of the adaptive filter 1 are exhibited. In the sub-RLS method, the coefficients Hⱼ are updated in accordance with the recursion formula,

Hⱼ₊₁=Sⱼ(Yⱼ−AⱼHⱼ) (3)

where

$$\begin{matrix}{S}_{j} = [ \begin{matrix}1 / {R}_{j} ( 1 , 1 ) & 0 & ⋯ & 0 \\ 0 & 1 / {R}_{j} ( 2 , 2 ) & ⋯ & 0 \\ ⋮ & ⋮ & ⋰ & ⋮ \\ 0 & 0 & ⋯ & 1 / {R}_{j} ( I , I )\end{matrix} ] , & ( 4 ) \\ {A}_{j} = [ \begin{matrix}0 & {R}_{j} ( 1 , 2 ) & ⋯ & {R}_{j} ( 1 , I ) \\ {R}_{j} ( 2 , 1 ) & 0 & ⋯ & {R}_{j} ( 2 , I ) \\ ⋮ & ⋮ & ⋰ & ⋮ \\ {R}_{j} ( I , 1 ) & {R}_{j} ( I , 2 ) & ⋯ & 0\end{matrix} ] , & ( 5 ) \\ {Y}_{j} = {[ \begin{matrix}{Y}_{j} ( 1 ) & {Y}_{j } ( 2 ) & ⋯ & {Y}_{j} ( I )\end{matrix} ]}^{T} , & ( 6 ) \\ {R}_{j} ( i , m ) = {y}_{j} ( i ) {y}_{j} ( m ) ( 1 - ρ ) + {R}_{j - 1} ( i , m ) ρ , and & ( 7 ) \\ {Y}_{j} ( i ) = ( {X}_{j} + {N}_{j} ) {y}_{j} ( i ) ( 1 - ρ ) + {Y}_{j - 1} ( i ) ρ . & ( 8 )\end{matrix}$$

In the equations (7) and (8), yⱼ(i) is the output of the i-th tap in the adaptive filter 1, i.e., the input signal yⱼ delayed for i sampling periods, and ρ is a forgetting coefficient defined as

ρ=1−μ/I, (9)

where μ is a constant satisfying

0<μ≦1. (10)

In the example of FIGS. 2(A) to 2(D), μ=0.1, and I=64.

As shown in FIGS. 2(A) to 2(D), in the output signal X′ⱼ of the noise suppression apparatus according to the present invention, the noise in the input signal yⱼ is suppressed, and the components of the original speech signal Xⱼ is emphasized.

(2) First Embodiment

The first embodiment of the present invention is explained below.

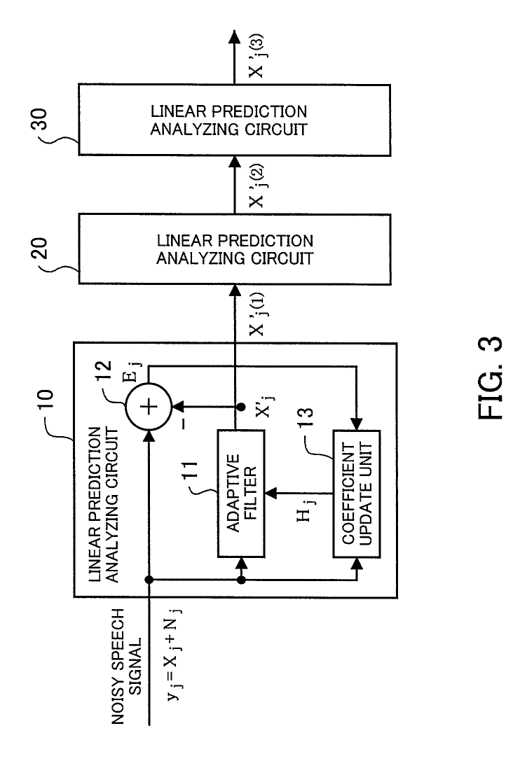

FIG. 3 is a diagram illustrating the construction of the noise suppression apparatus as the first embodiment of the present invention.

The noise suppression apparatus of FIG. 3 comprises three cascade-connected linear prediction analyzing circuits 10, 20, and 30. Since the three linear prediction analyzing circuits 10, 20, and 30 have an identical internal construction, the internal construction of only the linear prediction analyzing circuit 10 is exhibited in FIG. 3. Each of the linear prediction analyzing circuits 10, 20, and 30 has substantially the same construction as the basic construction of FIG. 1, and the adaptive filter 11, the subtraction unit 12, and the coefficient update unit 13 in FIG. 3 correspond to the adaptive filter 1, the subtraction unit 2, and the coefficient update unit 3 in FIG. 1, respectively.

The reason for the cascade-connection of more than one linear prediction analyzing circuit is explained below.

When a noise suppression apparatus is realized by using only one linear prediction analyzing circuit, the noise-suppression performance of the noise suppression apparatus corresponds to the performance of the adaptation algorithm in prediction of the coefficients Hⱼ. According to the reference of K. Fujii and J. Ohga, the performance of the adaptation algorithm in prediction of the coefficients Hⱼ increases with decrease in the value μ. However, when the value μ is small, the adaptation algorithm cannot follow phoneme change quickly, and consequently the noise suppression performance decreases. Therefore, the value μ cannot be decreased indiscriminately. That is, there is a limit to the performance of the noise suppression apparatus of FIG. 1.

Thus, in the first embodiment of the present invention, the constant μ is set to a relatively great value in each linear prediction analyzing circuit. Therefore, the noise suppression performance of each linear prediction analyzing circuit is decreased. However, since noise superimposed on a speech signal is suppressed step by step in the respective linear prediction analyzing circuits, the total noise suppression performance of the noise suppression apparatus of FIG. 3 increases. Therefore, the decrease in the noise suppression performance of each linear prediction analyzing circuit can be compensated for, by cascade-connection of a plurality of linear prediction analyzing circuits.

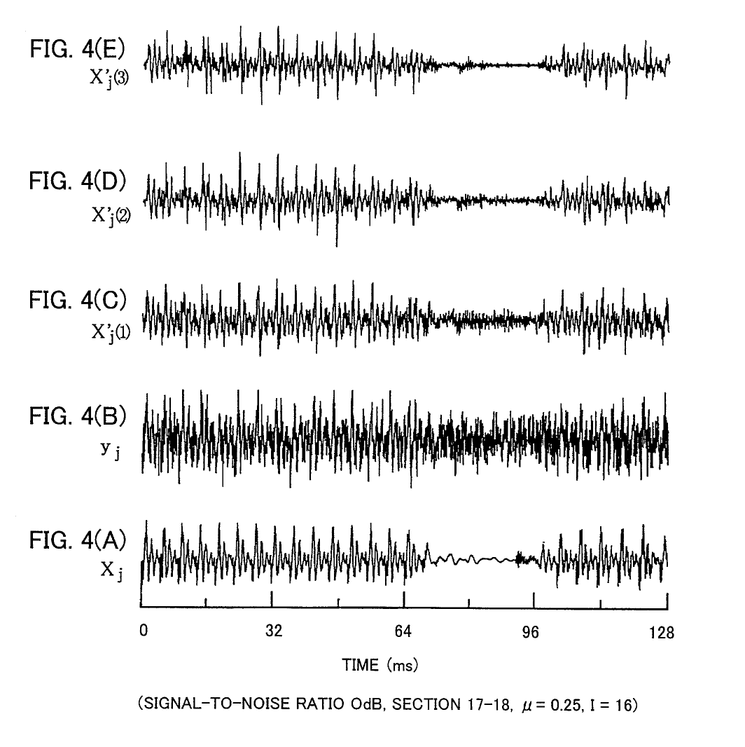

FIGS. 4(A) to 4(E) exhibit a result of noise suppression by repeating the operation of the sub-RLS method three times. In FIGS. 4(A) to 4(E), waveshapes of an original speech signal Xⱼ, an input signal yⱼ (=Xⱼ+Nⱼ) in which a noise signal Nⱼ is superimposed on the speech signal Xⱼ, a corresponding output signal X′ⱼ(1) of the linear prediction analyzing circuit 10, a corresponding output signal X′ⱼ(2) of the linear prediction analyzing circuit 20, and a corresponding output signal X′ⱼ(3) of the linear prediction analyzing circuit 30 are exhibited. In the example of FIGS. 4(A) to 4(E), μ=0.25, and I=16. As shown in FIGS. 4(A) to 4(E), the noise suppression performance is increased step by step.

However, in the noise suppression by cascade connection of a plurality of linear prediction analyzing circuits, a flaw which is produced in a linear prediction analyzing circuit in a stage of the cascade connection cannot be repaired in a subsequent stage. Therefore, it is difficult to increase the noise suppression performance of each linear prediction analyzing circuit. Accordingly, it is necessary to increase the number of cascade-connected linear prediction analyzing circuits.

(3) Second Embodiment

The second embodiment of the present invention is explained below.

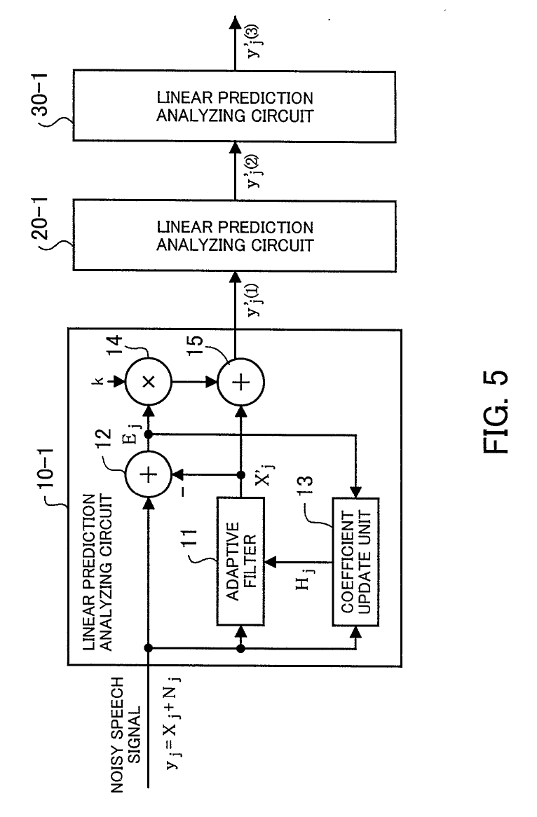

FIG. 5 is a diagram illustrating the construction of the noise suppression apparatus as the second embodiment of the present invention.

Each of the linear prediction analyzing circuits 10-1, 20-1, and 30-1 in the noise suppression apparatus as the second embodiment further comprises a speech signal repairing function using the prediction error signal. That is, each linear prediction analyzing circuit in the noise suppression apparatus of FIG. 5 comprises a multiplier 14 and an adder 15, in addition to the adaptive filter 11, the subtraction unit 12, and the coefficient update unit 13.

The prediction error signal Eⱼ output from the subtraction unit 12 contains a component which is lost from the output X′ⱼ of the adaptive filter 11. In the construction of the second embodiment, the component contained in the prediction error signal Eⱼ is utilized for repairing the speech signal. The multiplier 14 multiplies the prediction error signal Eⱼ by a constant k, and the adder 15 adds the output kEⱼ of the multiplier 14 to the output X′ⱼ of the adaptive filter 11. For example, k=0.25. Thus, the output y′ⱼ of each linear prediction analyzing circuit in the noise suppression apparatus of FIG. 5 is expressed as

y′ⱼ=X′ⱼ+kEⱼ. (11)

Thus, in each linear prediction analyzing circuit, a constant multiple (e.g., a quarter) of each component lost from the output X′ⱼ of the adaptive filter 11 is added to the output X′ⱼ of the adaptive filter 11. That is, a constant multiple of the lost component lost is recovered in the output X′ⱼ of each linear prediction analyzing circuit. Therefore, a high quality speech signal can be obtained through a plurality of cascade-connected linear prediction analyzing circuits.

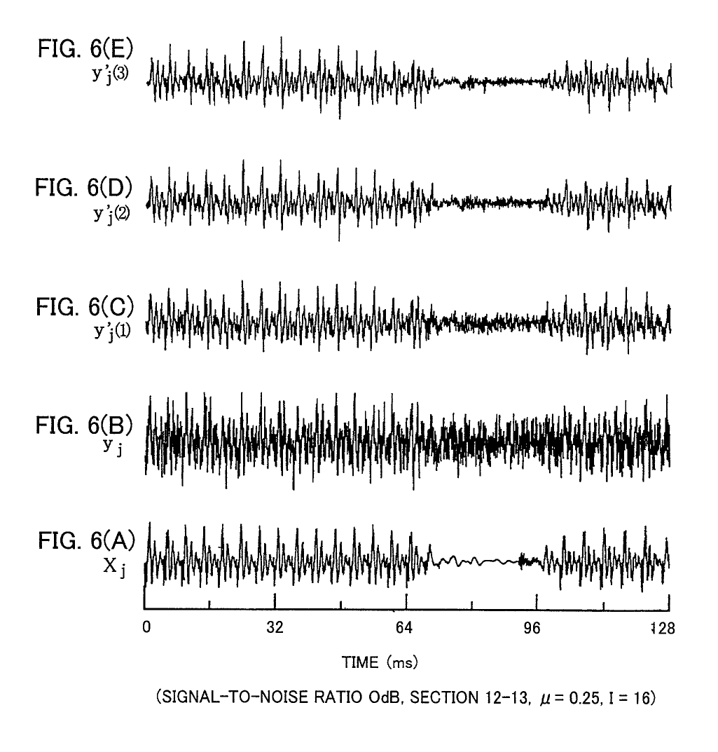

FIGS. 6(A) to 6(E) exhibit a result of noise suppression by the noise suppression apparatus of FIG. 5. In FIGS. 6(A) to 6(E), waveshapes of an original speech signal Xⱼ, an input signal yⱼ (=Xⱼ+Nⱼ) in which the noise signal Nⱼ is superimposed on the speech signal Xⱼ, a corresponding output signal y′ⱼ(1) of the linear prediction analyzing circuit 10-1, a corresponding output signal y′ⱼ(2) of the linear prediction analyzing circuit 20-1, and a corresponding output signal y′ⱼ(3) of the linear prediction analyzing circuit 30-1 are exhibited. In the example of FIGS. 6(A) to 6(E), μ=0.25, and I=16. As shown in FIGS. 6(A) to 6(E), the noise suppression performance is increased step by step.

(4) Third Embodiment

The third embodiment of the present invention is explained below.

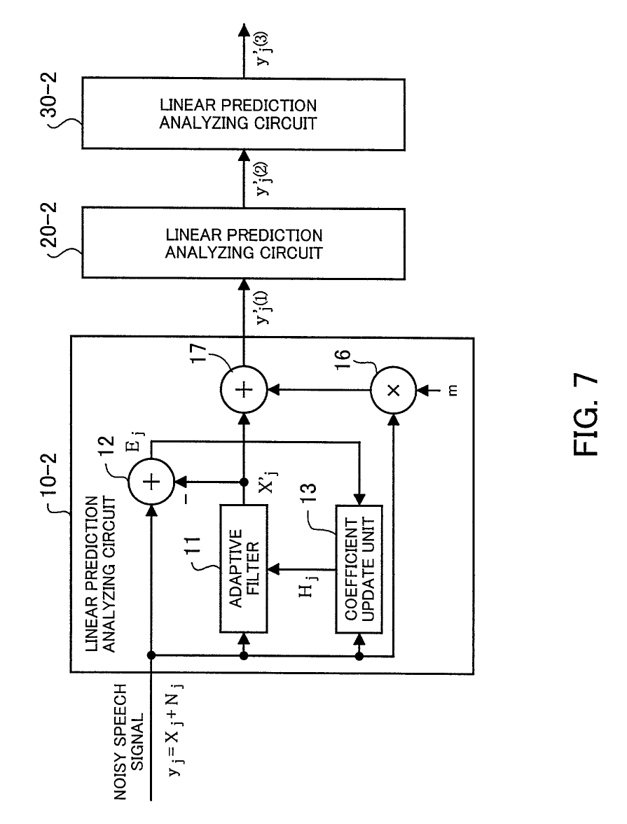

FIG. 7 is a diagram illustrating the construction of the noise suppression apparatus as the third embodiment of the present invention.

Each of the linear prediction analyzing circuits 10-2, 20-2, and 30-2 in the noise suppression apparatus of FIG. 7 comprises a multiplier 16 and an adder 17, in addition to the adaptive filter 11, the subtraction unit 12, and the coefficient update unit 13.

The multiplier 16 multiplies the input signal yⱼ by a constant m, and the adder 17 adds the output myⱼ of the multiplier 16 to the output X′ⱼ of the adaptive filter 11. Thus, the output y″ⱼ of each linear prediction analyzing circuit in the noise suppression apparatus of FIG. 7 is expressed as

y″ⱼ=X′ⱼ+myⱼ. (12)

Since the aforementioned equation (11) can be rewritten as

y′ⱼ=(1−k)X′ⱼ+kyⱼ, (13)

the noise suppression apparatus of FIG. 7 has an effect of repairing a speech signal which is similar to the effect of the second embodiment.

Thus, in each linear prediction analyzing circuit, a constant multiple (e.g., a quarter) of each component lost from the input signal yⱼ is added to the output X′ⱼ of the adaptive filter 11. That is, the output X′ⱼ of each linear prediction analyzing circuit is recovered by a constant multiple of the input signal yⱼ. Therefore, a high quality speech signal can be obtained through a plurality of cascade-connected linear prediction analyzing circuits.

(5) Fourth Embodiment

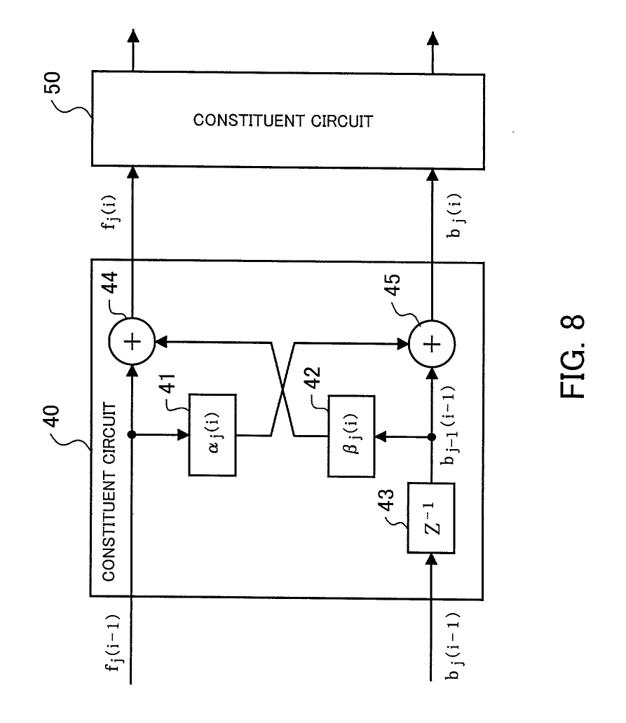

The linear prediction analyzing circuit realizing a noise suppression apparatus according to the present invention can be realized by a lattice filter. First, the construction of the lattice filter is explained below. FIG. 8 is a diagram illustrating a construction of a lattice filter. The lattice filter of FIG. 8 comprises a plurality of constituent circuits 40, 50 which are cascade-connected. Each constituent circuit 40, 50 comprises multipliers 41 and 42, a shift register 43, and adders 44 and 45.

Two input signals (fⱼ(i−1) and bⱼ(i−1)) are input into each (i-th) constituent circuit (40). The first input signal fⱼ(i−1) is input into the adder 44 and the multiplier 41, and the second input signal bⱼ(i−1) is input into the shift register 43. The shift register 43 holds the second input signal bⱼ(i−1) for one sampling period, and outputs an input signal bⱼ₋₁(i−1) which is delayed for one sampling period. The output bⱼ₋₁(i−1) of the shift register 43 is supplied to the adder 45 and the multiplier 42. The multiplier 41 multiplies the first input signal fⱼ(i−1) by a coefficient αⱼ(i), and the output αⱼ(i)fⱼ₋₁(i−1) of the multiplier 41 is supplied to the adder 45. The multiplier 42 multiplies the output signal bⱼ₋₁(i−1) of the shift register 43 by a coefficient βⱼ(i), and the output βⱼ(i)_{b}ⱼ₋₁(i−1) of the multiplier 42 is supplied to the adder 44. The adder 44 adds the output βⱼ(i)bⱼ₋₁(i−1) of the multiplier 42 to the first input signal fⱼ(i=1), and the output fⱼ(i−1)+βⱼ(i) bⱼ₋₁(i−1) of the adder 44 is supplied to the subsequent constituent circuit 50 as the first input fⱼ(i). The adder 45 adds the output αⱼ(i)fⱼ₋₁(i−1) of the multiplier 41 to the second input signal bⱼ₋₁(i−1) delayed for one sampling period, and the output bⱼ₋₁(i−1)+αⱼ(i)fⱼ₋₁(i−1) of the adder 45 is supplied to the subsequent constituent circuit 50 as the second input bⱼ(i). The coefficients αⱼ(i) and βⱼ(i) are defined as follows.

αⱼ(i)=Cⱼ(i)/Pⱼ(i), (14)

βⱼ(i)=Cⱼ(i)/Qⱼ(i), (15)

Cⱼ(i)=(1−ρ)fⱼ(i−1)bⱼ₋₁(i−1)+ρCⱼ₋₁(i), (16)

Pⱼ(i)=(1−ρ){fⱼ(i−1)}²+ρPⱼ₋₁(i), and (17)

Qⱼ(i)=(1−ρ){fⱼ₋₁(i−1)}²+ρQⱼ₋₁(i). (18)

Various definitions of the coefficients αⱼ(i) and βⱼ(i) are known for the lattice filter. The above coefficients αⱼ(i) and βⱼ(i) may be defined in other ways. The principle of the present invention is not changed by the definitions of the coefficients αⱼ(i) and βⱼ(i).

The fourth embodiment of the present invention is explained below.

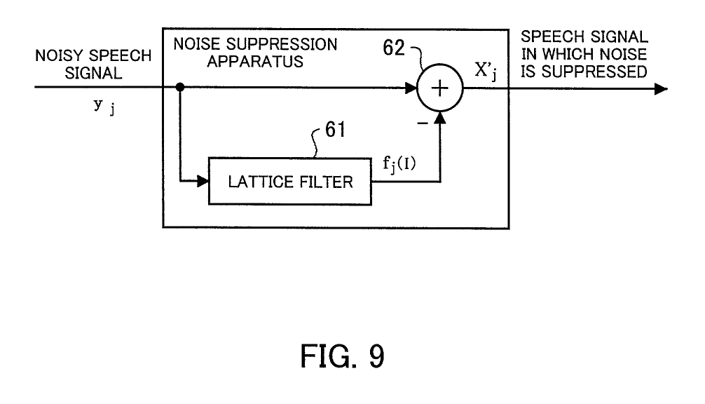

FIG. 9 is a diagram illustrating the construction of the noise suppression apparatus as the fourth embodiment of the present invention. The noise suppression apparatus of FIG. 9 comprises a lattice filter 61 and a subtractor 62. The input signal yⱼ is input into the lattice filter 61 and the subtractor 62. The output signal fⱼ(I) of the lattice filter 61 (i.e., the output of the final stage of the cascade connection of FIG. 8) indicates a prediction error, and corresponds to the prediction error signal Eⱼ in the construction of FIG. 1. The subtractor 62 subtracts the output signal fⱼ(I) of the lattice filter 61 from the input signal yⱼ, and the output of the subtractor 62 is the output signal of the noise suppression apparatus of FIG. 9. That is, the output signal of the noise suppression apparatus of FIG. 9 is expressed as

X′ⱼ=yⱼ−Eⱼ=yⱼ−fⱼ(I). (19)

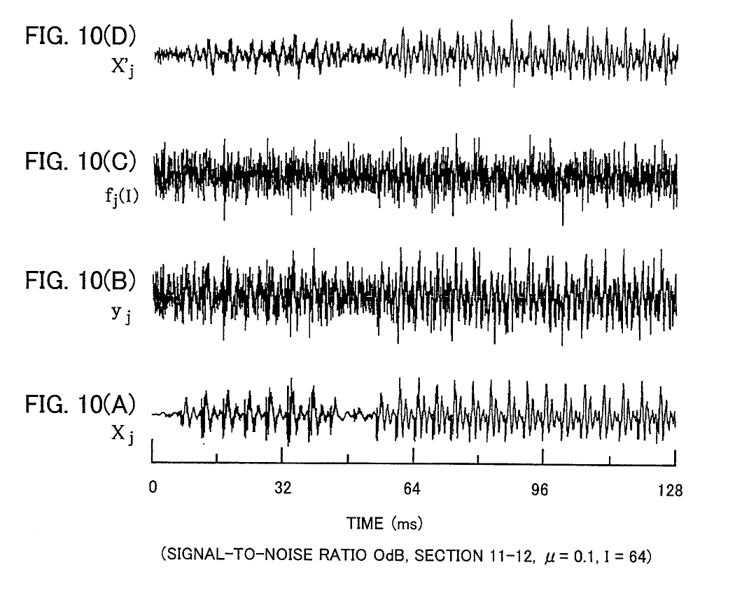

FIGS. 10(A) to 10(D) exhibit a result of noise suppression by the noise suppression apparatus of FIG. 9. In FIGS. 10(A) to 10(D), waveshapes of an original speech signal Xⱼ, an input signal yⱼ (=Xⱼ+Nⱼ) in which the noise signal Nⱼ is superimposed on the speech signal Xⱼ, a corresponding output signal fⱼ(I) of the lattice filter 61, and a corresponding output signal X′ⱼ of the noise suppression apparatus are exhibited. As shown in FIGS. 10(A) to 10(D), the noise suppression can also be achieved by using the lattice filter.

(6) Other Matters

(i) The functions of each embodiment of the present invention can be realized by using one or any combination of at least one microprocessor unit (MPU), at least one digital signal processor (DSP), and at least one hardware logic unit such as an application specific integrated circuit (ASIC).

(ii) The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

(iii) All of the contents of the Japanese patent application, No. 11-353491 are incorporated into this specification by reference.

What is claimed is:

1. A noise suppression apparatus comprising a linear prediction analyzing circuit which includes:
an adaptive filter which produces a linear prediction signal based on a first speech signal on which noise is superimposed, and outputs said linear prediction signal as a second speech signal in which said noise is suppressed;
a subtraction unit which obtains a difference between said linear prediction signal and said first speech signal, and outputs said difference as a prediction error; and
a coefficient updating unit which updates coefficients of said adaptive filter based on said first speech signal and said prediction error so as to minimize said prediction error.

2. A noise suppression apparatus comprising a cascade connection of first to n-th linear prediction analyzing circuits, where n is an integer greater than one, and each of said first to n-th linear prediction analyzing circuits includes:
an adaptive filter which produces a linear prediction signal based on a first speech signal on which noise is superimposed, and outputs said linear prediction signal as a second speech signal in which said noise is suppressed;
a subtraction unit which obtains a difference between said linear prediction signal and said first speech signal, and outputs said difference as a prediction error; and
a coefficient updating unit which updates coefficients of said adaptive filter based on said first speech signal and said prediction error so as to minimize said prediction error;
said second speech signal output from said n-th linear prediction analyzing circuit which is arranged in a final stage of said cascade connection is an output signal of said noise suppression apparatus, and said second speech signal output from each of said first to (n−1)-th linear prediction analyzing circuits is supplied to one of the second to n-th linear prediction analyzing circuits which is arranged in a subsequent stage as said first speech signal.

3. A noise suppression apparatus according to claim 2, wherein each of said first to n-th linear prediction analyzing circuits includes,
a multiplier which obtains a product of said prediction error and a predetermined constant, and
an adder which obtains as a third speech signal a sum of said product and said linear prediction signal, and
said third speech signal in said n-th linear prediction analyzing circuit, instead of said second speech signal, is said output signal of said noise suppression apparatus, and said third speech signal output from each of said first to (n−1)-th linear prediction analyzing circuits, instead of said second speech signal, is supplied to one of said second to n-th linear prediction analyzing circuits which is arranged in a subsequent stage as said first speech signal.

4. A noise suppression apparatus according to claim 2, wherein each of said first to n-th linear prediction analyzing circuits includes,
a multiplier which obtains a product of said first speech signal and a predetermined constant, and
an adder which obtains as a third speech signal a sum of said product and said linear prediction signal, and
said third speech signal in said n-th linear prediction analyzing circuit, instead of said second speech signal, is said output signal of said noise suppression apparatus, and said third speech signal output from each of said first to (n−1)-th linear prediction analyzing circuits, instead of said second speech signal, is supplied to one of said second to n-th linear prediction analyzing circuits which is arranged in a subsequent stage as said first speech signal.

5. A noise suppression apparatus comprising a linear prediction analyzing circuit which includes:
a lattice filter which produces a linear prediction signal based on a first speech signal on which noise is superimposed; and
a subtraction unit which subtracts said linear prediction signal from said first speech signal, and outputs a remainder after subtraction, as a second speech signal in which said noise is suppressed.
